(19) United States
(12) Patent Application Publication
(10) Pub. No.: US 2005/0144308 A1
(43) Pub. Date: Jun. 30, 2005

(54) Method for managing file transfer actions, method for visualizing file transfer actions, and apparatus for managing file transfer actions and user terminals in file transfer system

(76) Inventors: Ichiro Harashima, Hitachiota (JP); Keiji Doi, Hitachi (JP); Toshiya Abe, Hitachi (JP); Norito Watanabe, Hitachi (JP); Hiroyuki Yuchi, Yokohama (JP)

Correspondence Address: DICKSTEIN SHAPIRO MORIN & OSHINSKY LLP, 2101 L Street, NW, Washington, DC, 20037, US

(21) Appl. No.: 10/786,545

(22) Filed: Feb. 26, 2004

(30) Foreign Application Priority Data
Dec. 24, 2003 (JP) 2003-427983

(51) Int. Cl. G06F 15/16; G06F 17/30

(52) U.S. Cl. 709/232; 707/200

(57) ABSTRACT

A system that manages non-routine file transfer actions efficiently. An apparatus for managing file transfer actions performs the steps of accepting entry of a file to be made open or the file's attribute information that identifies one of the transfer actions of the file, creating new attribute information for the file to be made open not including the attribute information and adding the new attribute information to the file, updating the attribute information for the file to be made open including the attribute information, storing combination of the identifier of the file to be made open and the attribute information added to the file into a file transfer actions database. The attribute information comprises a unique ID to uniquely identify a file, a sub-ID to uniquely identify one of transfer actions of the file, and a parent sub-ID which is included in updated attribute information to indicate its parent.

### FIELD OF THE INVENTION

The present invention relates to a method for managing file transfer actions, a method for visualizing file transfer actions, and an apparatus for managing file transfer actions and user terminals in a file transfer system.

### BACKGROUND OF THE INVENTION

When development work is carried out by a plurality of members engaged in the work, information relevant to the development including specifications and drawings, which was previously transferred in printed form among the members, is transferred in files in electrical form among the work participants. In general, these files are stored and managed on file servers referred to as Product Data Management (PDM) and the like which essentially constitute a document management system and a product data management. Thereby, vast amounts of documents can be shared among an enormous number of people who are engaged in the work even in a distributed environment. As for the electronic files, for example, a system for displaying relationships between the plurality of files has been proposed (refer to Japanese Patent Document Cited 1). In cases where the development work is carried out via the electronic files, the work can be divided into routine operations and non-routing operations.

First, the routine operations in which file delivery flows are predetermined can be expected to enhance operation efficiency and quality by scheduling the operation to flow in routines (templates) and are especially suitable for clerical work requiring circulating documents, examination, and authorization. In order to perform these routine operations efficiently, a workflow system is implemented which well defines an overall operation flow by way of business process modeling, builds a workflow, based on the defined business process model, and carries out the operations in conjunction with the document management system.

As an example of implementation of the routine operations, a method for generating a workflow has been proposed (refer to Japanese Patent Document Cited 2), wherein, by using a database of documents associated with tasks (operations), which is prepared in advance, a sequential relationship among the tasks is determined, according to the sequence in which the documents are created and referenced, and the workflow is generated accordingly.

As another example of implementation of the routine operations, the following project management method is generally used: after entering process-related information such as operation start and completion schedules and progress to work items of a Work Breakdown Structure (WBS) which was conventionally used to define detailed phases of operations fractionized for operation process management and project management, such information is visualized in a form such as a Gantt chart so that the information is shared across process managers and persons in charge.

The above-discussed methods of implementation of the routine operations make centralized management easy because workflow information and project information are stored on the servers in both the examples and are believed to be applied easily to cases where work is carried out by certain divisions of an organization that each have distinct functions and responsibilities, like the case of a development project pursued by a company.

[Japanese Patent Document Cited 1] JP-A No. 190588/1996

[Japanese Patent Document Cited 2] JP-A No. 27203/1998

Meanwhile, the non-routine operations without predetermined operation flows are also performed via the files in electronic form. For example, the non-routine operations are implemented by using peer-to-peer technology by which files existing in individuals' computers are exchanged among an unspecified number of users via e-mail, a file server, and a network such as the Internet. These non-routine operations are performed in a workflow on a further detailed level, based on an outline operation flow involving, for example, planning of a product, outline design, detailed design, etc., and characterized in that operation is carried out concurrently among a plurality of divisions and modeling is difficult. An instance where the non-routine operations take place is the initial phase of a project for developing a product which may be either software or hardware.

To manage these non-routine operations efficiently, a system for efficient management of actions of transferring files among the work participants, which are performed in a non-routine manner, however, has not been proposed heretofore. It is hard to apply conventional systems for management of routine operations to non-routine operations that operation details vary to a great extent, because the above systems are built on the assumption of modeling from the routine operations.

For example, the system disclosed in Japanese Patent Document Cited 1 presents only a relationship between a particular file and another file, but does not present how the particular file has been transferred from one work participant to another participant. Thus, this system does not fulfill the purpose of presenting file transfer actions which are performed in a non-routine manner.

### SUMMARY OF THE INVENTION

It is therefore a primary object of the present invention to propose a system for efficient management of non-routine file transfer actions as a solution to the above-discussed problem.

In order to solve the above problem and in accordance with a first aspect of the invention, a method for managing file transfer actions is provided for use in a file transfer system comprising user terminals among which file transfer actions are performed and an apparatus for managing the file transfer actions among said user terminals. The above method comprises the following steps which are performed by the above apparatus: accepting entry of a file to be made open (or public) or the file's attribute information that identifies one of the transfer actions of the file, creating new attribute information for the file to be made open not including the attribute information and adding the new attribute information to the file, updating the attribute information for the file to be made open including the attribute information, storing combination of the identifier of the file to be made open and the attribute information added to the file into a file transfer actions database. The above new attribute information comprises a unique ID different from any previously issued unique ID and an arbitrary sub-ID. The updated attribute information comprises a unique ID inherited from the attribute information from which the update derives, a sub-ID different from any previously issued sub-ID under the unique ID, and a parent sub-ID identical to the sub-ID from the attribute information from which the update derives. Other aspects and features of the present invention will be set forth in the following detailed description of the preferred embodiments.

The present invention creates attribute information of a file, according to the transfer actions of the file and, consequently, can visualize the file transfer actions, based on that information. Therefore, the present invention makes it possible to grasp a comprehensive state of operations with the display of file flows even for cases where a development project is carried out without well-defined organization structure and distinct functions and responsibilities and even for projects where a plurality of operations are concurrently performed; for instance, software development that is carried out by an unspecified number of skillful volunteers or an initial stage of development even if the development is implemented by a company.

### BRIEF DESCRIPTION OF THE DRAWINGS

FIG. 1 is a topology diagram of a peer-to-peer file transfer system example according to a preferred embodiment of the present invention.

FIG. 2 shows a file transfer actions database structure involved in the preferred embodiment of the present invention.

FIG. 3 is a diagram showing file transfer flows and how attribute information is assigned to work participants in accordance with the transfer flows, involved in the preferred embodiment of the present invention.

FIG. 4 is a flowchart to describe a process for loading a file to be made open into the directory, involved in the preferred embodiment of the present invention.

FIG. 5 shows a GUI screen which a user terminal displays, involved in the preferred embodiment of the present invention.

FIG. 6 is a flowchart to describe a process for receiving an open file, involved in the preferred embodiment of the present invention.

FIG. 7 is a flowchart to describe a process for visualizing file transfer actions, involved in the preferred embodiment of the present invention.

FIG. 8A shows a flow model presentation screen example, involved in the preferred embodiment of the present invention.

FIG. 8B shows another flow model presentation screen example.

FIG. 9 shows a history information presentation screen example, involved in the preferred embodiment of the present invention.

FIG. 10 shows a file transfer system of client-server topology, according to another embodiment of the present invention.

### DETAILED DESCRIPTION OF THE PREFERRED EMBODIMENTS

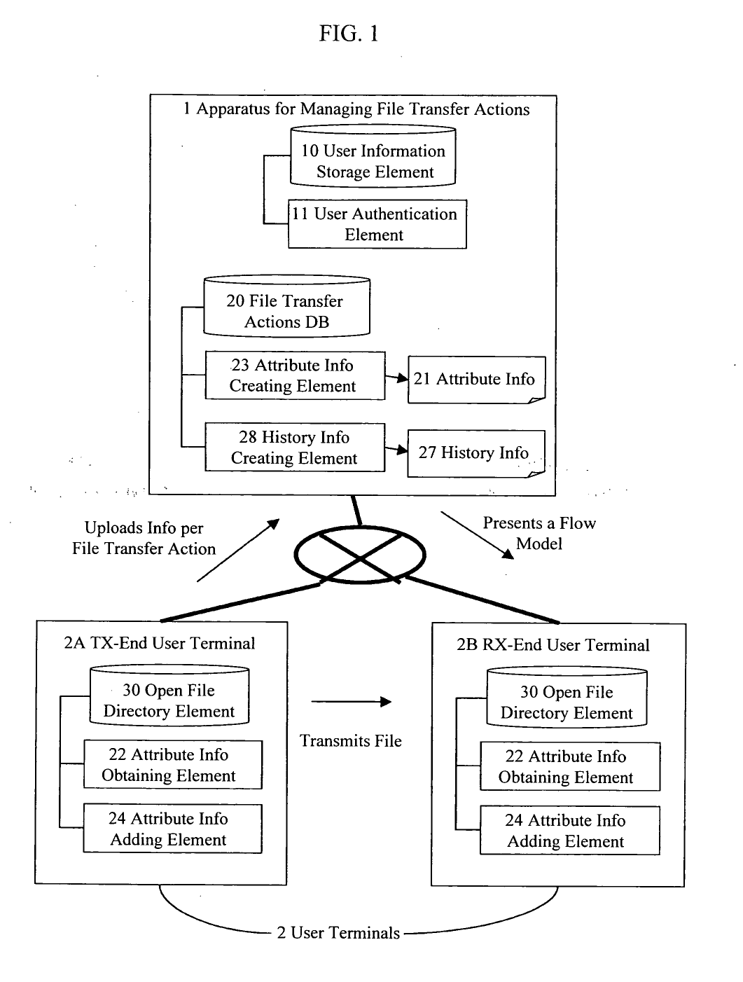

A preferred embodiment of a file transfer system to which the present invention is applied will be described hereinafter with reference to the accompanying drawings. The configuration of the file transfer system of the present embodiment is first explained with reference to FIGS. 1 through 3.

The file transfer system shown in FIG. 1 has a function to visualize non-routine file transfer actions. To realize this function, the file transfer system comprises an apparatus for managing file transfer actions 1 which manages file transfer actions and visualizes the state of the file transfer actions and user terminals 2 which perform the file transfer actions, wherein the apparatus and the terminal devices are interconnected by a network. In this embodiment, the user terminals 2 can be divided into a user terminal 2A at a file transmitting end and a user terminal 2B at a file receiving end, according to the direction in which a file is assumed to be communicated between the terminals.

This embodiment in FIG. 1 is an example of peer-to-peer topology in which files that the transmitting-end user terminal 2A has are directly transmitted to the receiving-end user terminal 2B. This is because the file transfer system is assumed to be used by an unspecified number of work participants who work cooperatively and building the system of peer-to-peer topology is desirable from this assumption.

The apparatus for managing file transfer actions 1 primarily comprises a user information storage element 10 in which information for users who perform file transfer actions is stored and managed for authenticating the users of the user terminals 2 that are getting access to the apparatus and a user authentication element 11 which authenticates the users who perform file transfer actions. Like this, by providing the apparatus with means for authenticating the work participants (the users of the user terminals 2), the reliability of attribute information 21 corresponding to file transfer actions and history information 27 is enhanced and the reliability of the contents of data files transferred among the work participants is enhanced as well.

The apparatus for managing file transfer actions 1 further comprises an attribute information creating element 23 which creates the attribute information 21 that identifies a file transfer flow and a history information creating element 28 which creates history information 27 about the transfer actions that have been performed on the files. Created information relevant to the file transfer actions (attribute information 21 and history information 27) is stored and managed on a file transfer actions database (DB) 20 that is included in the apparatus for managing file transfer actions 1.

Each of the user terminals 2 comprises an attribute information obtaining element 22 through which the terminal gets attribute information 21 attached to a file in order to transfer the file, an attribute information adding element 24 which adds attribute information 21 associated with a file to the file, and an open file directory element 30 into which a file to be made open is stored.

The above attribute information adding element 24 may add attribute information 21 to a data file through one of diverse methods. The methods of adding attribute information include the following: for example, if a data file has a section where attribute information 21 should be stored and this section is available, specify attribute information 21 in this section; embed strings corresponding to attribute information into a redundant data portion of the contents of a data file, for example, image data, by using a “digital watermarking” technique; combine a data file and its attribute information 21 into one file (package file) by data compression.

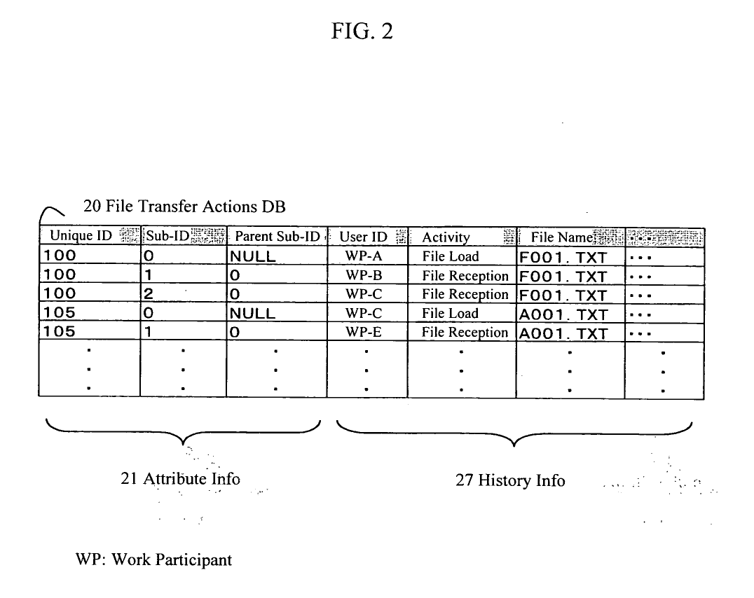

FIG. 2 shows an exemplary structure of the file transfer actions DB 20. Attribute information 21 that is managed on the file transfer actions DB 20 comprises a file's unique ID to distinguish the file from other files, a sub-ID to identify a delivery action of the file in the past, and a parent sub-ID from which the file was delivered, as labeled by the sub-ID.

The unique ID is the ID that can identify the data file throughout its lifecycle. A file name which is commonly used to identify a file is generally the name that the creator of the data file arbitrarily has assigned to the file. However, using only the file name to identify a particular file cannot eliminate the possibility of the file name being identical to another file name assigned by another work participant and the possibility of the file name being changed by a work participant as the data file is transferred from one terminal to another in a chain. If the file name is changed, the history of the file before that time becomes untraceable. As a countermeasure to prevent these occurrences, the system of the present embodiment uses the unique file ID to identify a particular file instead of the file name so that the data file label will not change while the file is passed on among a plurality of work participants.

History information 27 that is managed on the file transfer actions DB 20 comprises a user ID to identify the user who requested a file transfer action, activity to indicate the type of the file transfer action, a file name assigned to the file. The history information 27 may further comprise the time and date when the file transfer action was performed, contents information to describe the contents of the file, and file type to indicate the type of the file.

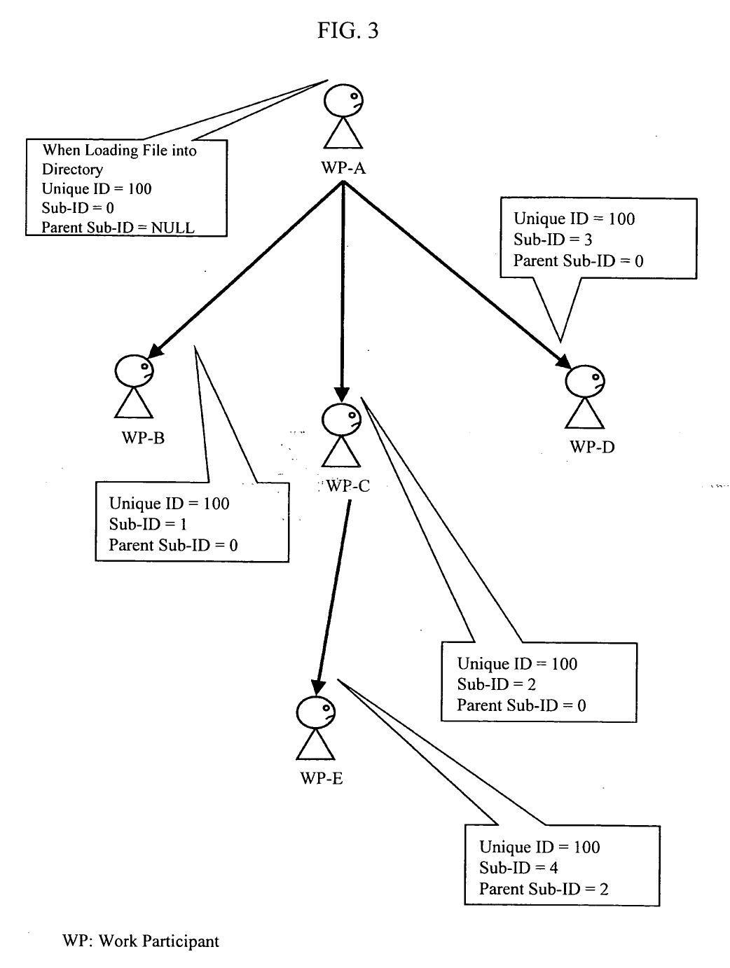

FIG. 3 is a diagram showing file transfer flows and how attribute information 21 is assigned to work participants in accordance with the transfer flows. FIG. 3 shows the flows of transfers of a particular file (identified by unique ID) among user terminals 2 used by five work participants, respectively. A file transfer action is indicated by an arrow line connecting one work participant node to another work participant node. The start point of the arrow line is the source from which the file is transferred and the end point of the arrow line is the destination to which the file is transferred. Thus, FIG. 3 shows the flows in which the file is transmitted from work participant A to three work participants (B, C, and D) and, from the work participant C, the file is further transmitted to work participant E. The file transfer actions pass on non-routine data in the file separately transferred from one work participant to another one, not routine data like those that are supplied in a batch beforehand.

In the following, attribute information 21 that is created by the attribute information creating element 23 will be explained in detail. The file transfer actions shown in FIG. 3 pertain to transferring the particular file identified by unique ID. Thus, if a file having unique ID that is different from the unique ID of the particular file is transferred, then, there must be another flow of transfer action not shown in FIG. 3. Sub-IDs are created each time loading a file to the directory (to set the file open) is performed and each time a file transfer action (communicating the file from the source to the destination) is performed. Specifically, when the file is transmitted from work participant A to three work participants (B, C, and D), the file is transferred to different destinations, though the file has the same contents. Consequently, different sub-IDs are assigned for the destinations, respectively. By the sub-IDs, the file transfer actions can be identified.

Moreover, a parent sub-ID is assigned and the sub-ID value assigned to the preceding file transfer action in the flow tree is used as the parent sub-ID. For example, look at the file transfer action from work participant A to participant C and the file transfer action from work participant C to participant E. First, when work participant A loads the file into the directory (to set the file open), sub-ID “0” is assigned. At this time, a parent sub-ID is not defined and is set to “NULL.” Then, when the file transfer action from work participant A to participant C is performed, the sub-ID “0” that was assigned to the file as the result of the preceding action is copied and set as its parent sub-ID “0” and a sub-ID (for example, “2”) that has not been assigned to the file is assigned as a new sub-ID. Furthermore, when the file transfer action from work participant C to participant E is performed, the sub-ID “2” that was assigned to the file as the result of the preceding action is copied and set as its parent sub-ID “2” and a sub-ID (for example, “4”) that has not been assigned to the file is assigned as a new sub-ID.

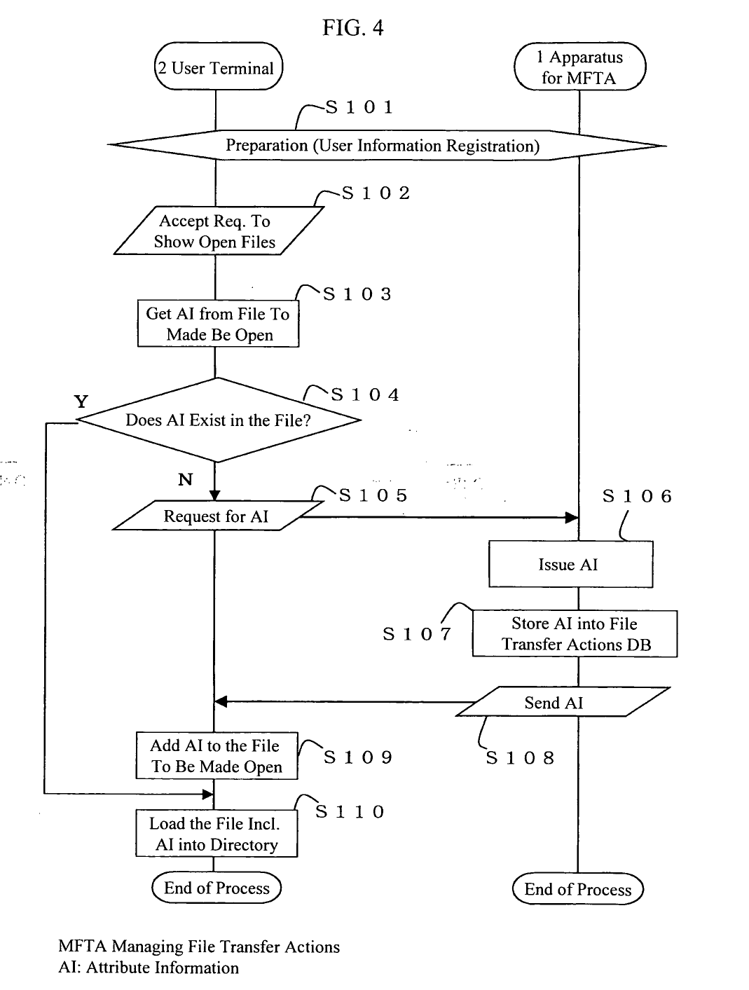

The file transfer system is configured as described hereinbefore. Next, a process for loading a file to be made open into the directory, one of the facets of operation of the file transfer system of the present embodiment, will be described with reference to FIGS. 1 and 2 and in accordance with FIG. 4.

FIG. 4 is a flowchart to describe the process for loading a file to be made open into the directory. First, user information is registered with the apparatus for managing file transfer actions 1 in preparation for this process (S101). The user information is data that is used for the user authentication element 11 to authenticate the user of a user terminal 2 that is getting access to the apparatus for managing file transfer actions 1 and is stored into the user information storage element 10

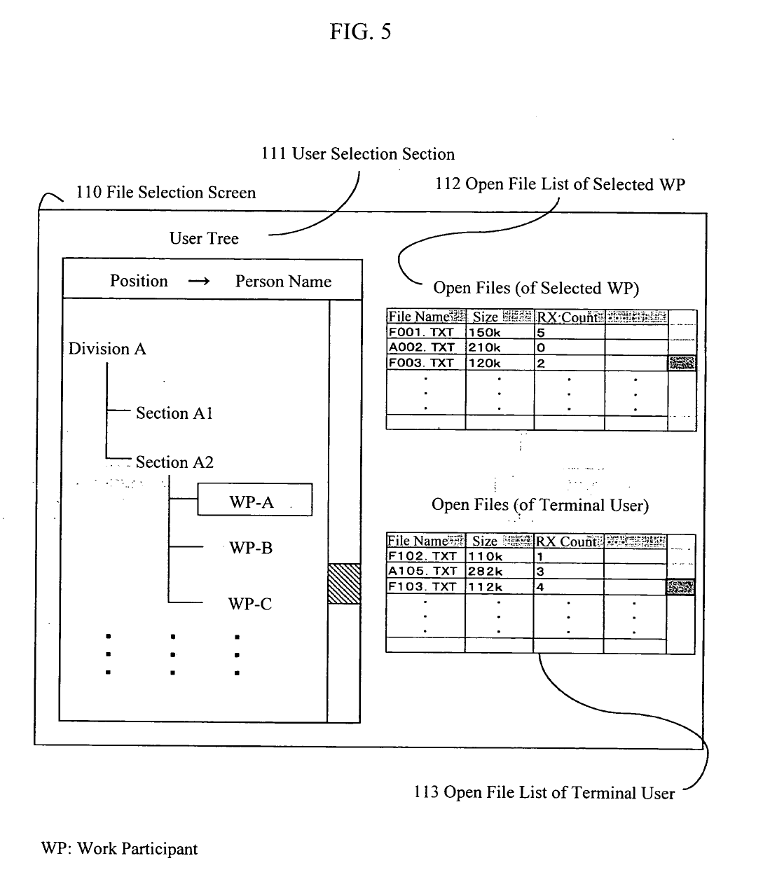

The user information consists of, for example, combination of user ID and user-specific data required for authentication. The user-specific data includes, for example, a password, the IP address or MAC address of the user terminal 2, and e-mail address uniquely assigned to the user. The user information may include additional user information such as the position and post of the user so that selecting a user in the user selection section 111 of a file selection screen (see FIG. 5) can be performed more conveniently. The user selection section 111 has a scroll bar (represented by a shaded rectangle) on its right edge to allow the user to scroll the screen if a user list is longer than one screen size.

Next, the user terminal 2 accepts a request to show open files (S102). Then, the user terminal 2 presents the selection screen 110 shown in FIG. 5 to prompt the user to confirm open files and select a file to be made open. The selection screen 110 includes an open file list section 113 where open files of the local terminal user are listed, so that the user can confirm the list of his or her open files. Selection of a file to be made open is performed by, for example, dragging and dropping a file to be made open into the user's open file list section 113. The user terminal 2 gets attribute information 21 from the file specified to be made open through the attribute information obtaining element 22 (S103).

Then, the user terminal 2 checks whether attribute information 21 exists in the file to be made open (S104). If attribute information 21 exists in the file, the user terminal 2 directly loads the file including the attribute information 21 into the directory (S110), and the process terminates. If attribute information 21 does not exist, the user terminal 2 sends a request for attribute information 21 to the apparatus for managing file transfer actions 1 in order to add the attribute information 21 to the file to be made open (S105). The apparatus for managing file transfer actions 1 authenticates the user of the user terminal 2 on the basis of the user information. If the user authentication is successful, in response to the request from the user terminal 2, the apparatus 1 performs the following steps.

After receiving the request for attribute information 21 (S105), the apparatus for managing file transfer actions 1 issues the appropriate attribute information 21 (S106). Specifically, the attribute information creating element 23 issues the attribute information 21 (unique ID, sub-ID, and parent sub-ID “NULL”) for the file to be loaded for the first time into the directory, as shown in FIG. 3 as exemplary attribute values for work participant A. The apparatus for managing file transfer actions 1 stores the created attribute information 21 into the file transfer actions DB 20 (S107). Then, the apparatus for managing file transfer actions 1 sends the attribute information 21 to the user terminal 2 so that the attribute information 21 will be added to the file to be made open (S108).

Then, the attribute information adding element 24 of the user terminal 2 adds the received attribute information 21 to the file to be made open (S109). The user terminal 2 loads the file including the attribute information 21 into the open file directory element 30 (S110).

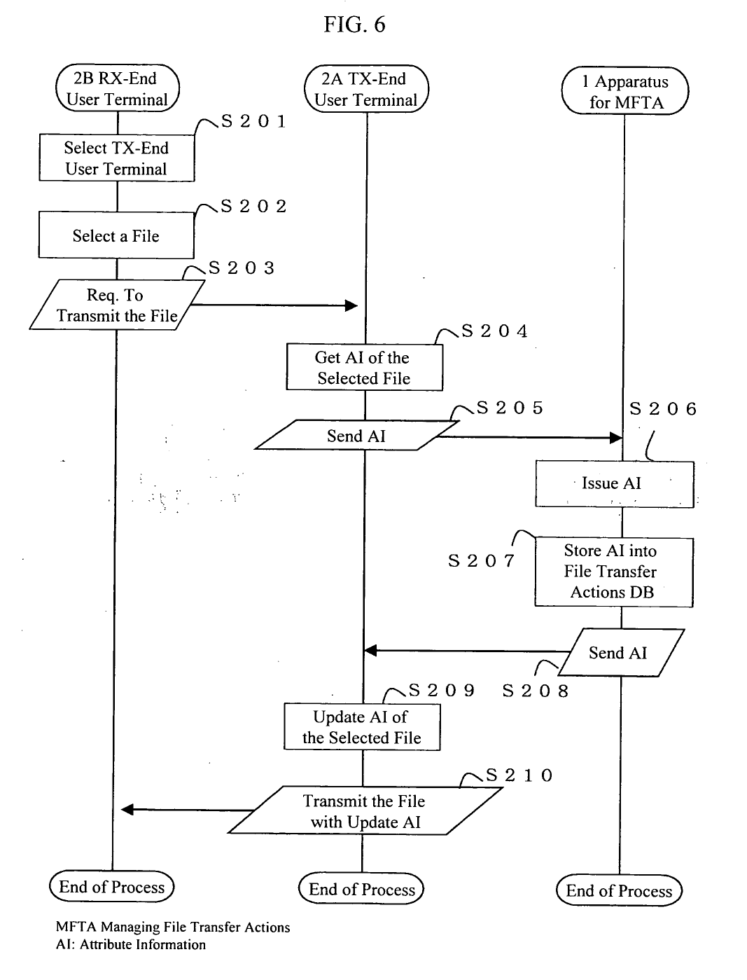

The process for loading a file to be made open into the directory is carried out as described above. Next, a process for receiving an open file, one of the facets of operation of the file transfer system of the present embodiment, will be described with reference to FIGS. 1 to 5 and in accordance with FIG. 6. FIG. 6 is a flowchart to describe the process for receiving an open file in the file transfer system.

First, the user of an RX-end user terminal 2B selects a TX-end user terminal 2A (S201). Concretely, the RX-end user terminal 2B presents the file selection screen 110 of FIG. 5. The RX-end user terminal 2B prompts the user to select a user who is a work participant from which the user wants to receive a file via the user selection section 111. The user selection section may present a plurality of users sorted by position so that a desired user can be selected from the plurality of users more conveniently.

Then, the RX-end user terminal 2B user selects a file (S202). The file selection screen 110 of FIG. 5 includes an open file list section 112 where open files of the work participant user selected (S201) in the user selection section 111 are listed. The RX-end user terminal 2B prompts the user to select a file that the user wants to get from the open file list 112 of the selected work participant. After selecting a file, when the user drags and drops the selected file into the open file list 113 of the terminal user, the RX-end user terminal 2B sends a request to transmit the file to the TX-end user terminal 2A (S203).

Then, the TX-end user terminal 2A receives the request to transmit the file and gets the attribute information 21 of the selected file (S204). The TX-end user terminal 2A sends the attribute information 21 (obtained in S204) to the apparatus for managing file transfer actions 1 in order to update the attribute information 21 of the selected file (S205).

Then, the apparatus for managing file transfer actions 1 receives the attribute information 21 and issues new attribute information 21 (S206). Specifically, the attribute information creating element 23 creates the appropriate attribute information 21 for the file to be transmitted, as shown in FIG. 3 as exemplary attribute values for work participant B and the like. As described above, the new attribute information 21 comprises, in addition to the unique file ID, a sub-ID for which a value that has not been assigned previously for the file to be transmitted is assigned and a parent sub-ID for which the sub-ID included in the received attribute information 21 is assigned.

The apparatus for managing file transfer actions 1 stores the new attribute information 21 into the file transfer actions DB 20 (S207). The apparatus for managing file transfer actions 1 sends the new attribute information 21 to the TX-end user terminal 2A (S208).

The TX-end user terminal 2A updates the obtained attribute information 21 (obtained in S204) for the selected file to the new attribute information 21 (issued in S204) (S209). In this relation, the attribute information 21 may be updated by replacing the previous attribute information 21 with the new attribute information 21 or by adding the new attribute information 21 while preserving the previous attribute information 21. Then, the TX-end user terminal 2A transmits the file with the updated attribute information 21 to the RX-end user terminal 2B (S210).

The process for receiving an open file is carried out as described above. Through this process, a data file required for the work of a work participant or a data file produced by the work of a work participant is transferred from a terminal used by one work participant to a terminal used by another participant. Such file transfer actions among the work participants are monitored and, based on the result of the monitoring, workflows are generated on a data file basis, unlike routine workflows which are defined initially. As a result, a network with high flexibility can be built for non-routine operations for which process modeling was considered difficult previously. The workflows are stored in to the file transfer actions DB 20.

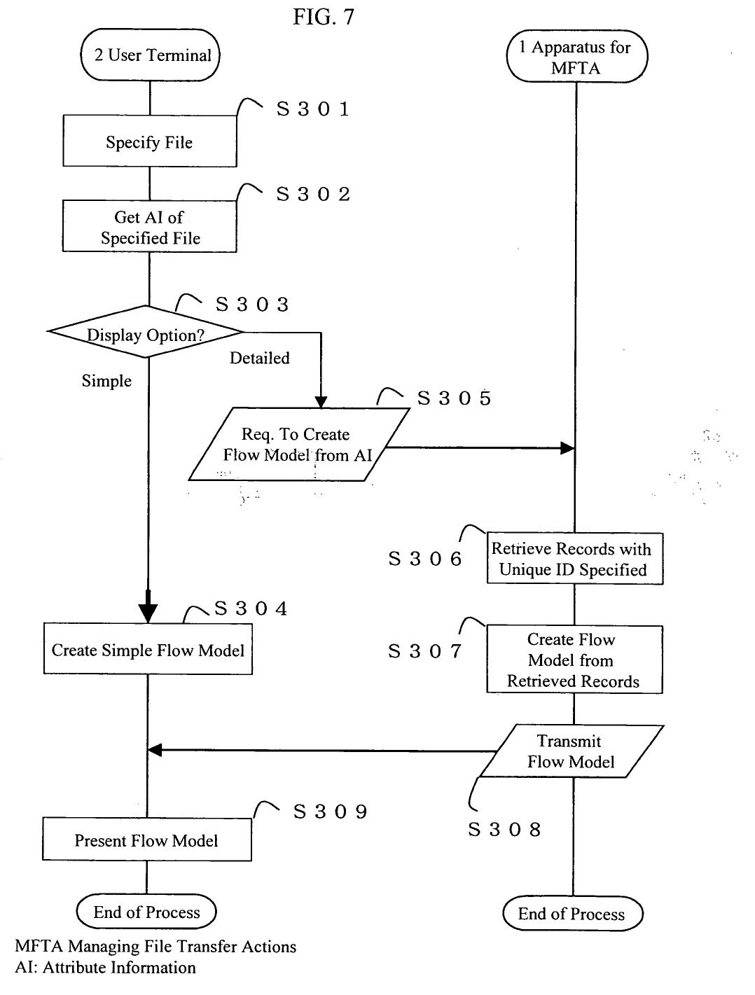

Next, a process for visualizing file transfer actions, one of the facets of operation of the file transfer system of the present embodiment, will be described with reference to FIGS. 1 to 6 and in accordance with FIG. 7. FIG. 7 is a flowchart describing the process for visualizing file transfer actions in the file transfer system.

First, the user terminal 2 prompts the user to specify a file for which to display a flow model (S301). Then, the user terminal 2 gets the attribute information 21 of the specified file through the attribute information obtaining element 22 (S302).

Then, the user terminal 2 asks the user to choose one of flow model display options (S303). If the user chooses a simple display option, then the user terminal 2 creates a simply flow model (S304). The user terminal 2 presents the created simple flow model (S309), and the process terminates.

Here, the simple flow model will be explained in concrete terms. The simple flow model is a flow model that is created straightforwardly from the attribute information 21 obtained from the file for which the flow model is to be displayed without requiring the user terminal 2 to communicate with the apparatus for managing file transfer actions 1. Thus, the requirement for creating this flow model is that the file transferred from another user terminal includes the attribute information 21. From only a part of the file transfer actions of the file for which the flow model is to be displayed (the transfer actions that can be derived from the attribute information 21 attached to the file), the flow model is created.

For instance, a case where the user terminal 2 of work participant E in FIG. 3 creates a simple flow model is discussed. First, the user terminal 2 of work participant E receives a particular file (with unique ID=100) from the user terminal 2 of work participant C. The received file includes the attribute information 21 regarding the file transfer actions, that is, all sub-IDs assigned to it in the past (sub-IDs 0, 2, and 4). Based on these sub-IDs, the user terminal 2 of work participant E creates a simple flow model. Thus, the created flow model represents a direct flow from the source of the file to the final recipient of the file (work participant A→participant C→participant E). However, this simple flow model excludes the file transfer actions that the file recipients do not have direction connection with the above direct flow, that is, those in branch flows (work participant A→participant B and work participant A→participant D), because the attribute information 21 of the file received by the work participant E does not include information regarding the branch flows.

The above-discussed simple flow model has a feature that it is presented quickly because of no need for communication with the apparatus for managing file transfer actions 1. Thus, the user can identify quickly the source of the file (upstream) in the direct flow course of the file transfer actions and can immediately notify the source of the file of a problem regarding the file if it occurs.

If the user chooses a detailed display option, then the user terminal 2 sends the apparatus for managing file transfer actions 1 a request to create a flow model from the attribute information 21 (S305). The apparatus for managing file transfer actions 1 receives the request to create a flow model and retrieves records having the unique file ID specified in the request (S306). Thereby, the apparatus for managing file transfer actions 1 can extract the records for the file transfer actions of an arbitrary file as shown in FIG. 3, because the transfer actions of a file initially delivered from the same source are assigned the same unique ID.

Then, the apparatus for managing file transfer actions 1 creates a flow model from the retrieved records (S307). Among these records, by connecting a record with a parent sub-ID to a record whose sub-ID matching the parent sub-ID, the apparatus for managing file transfer actions 1 creates a tree structure of one flow model from the plurality of records. The root of the tree corresponds to the work participant's node on which the file was initially loaded into the directory. Then, the apparatus for managing file transfer actions 1 transmits the created flow model to the user terminal 2 (S308). The user terminal 2 presents the flow model by using a flow model presentation screen 120 (S309).

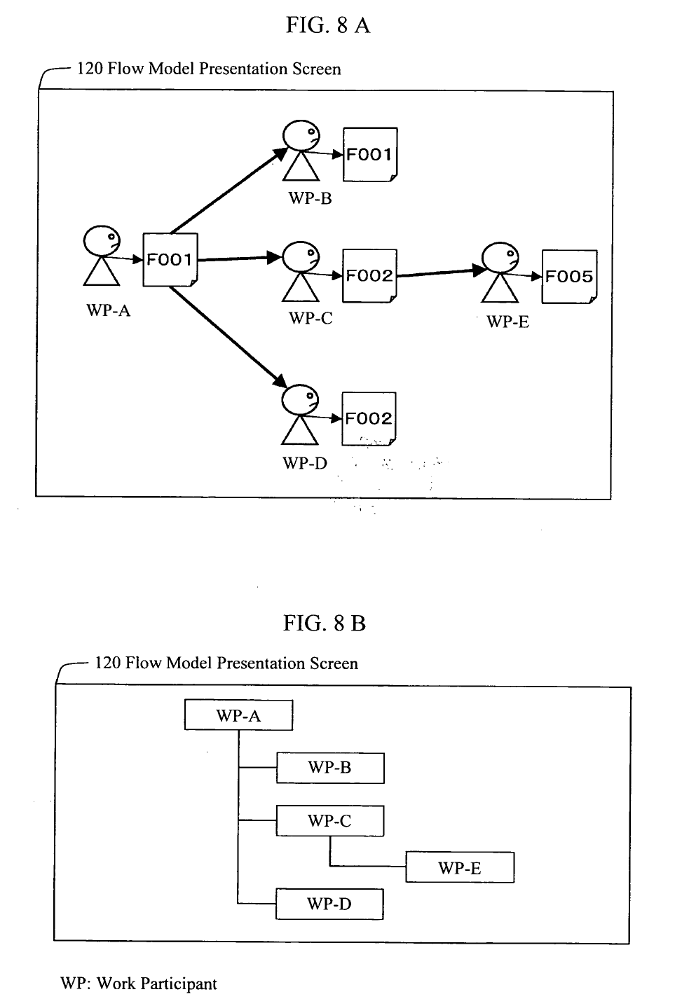

The flow model presentation screen 120 can present a tree structure of a flow model in diverse styles. For example, the screen may present a view in which the nodes of a tree structure correspond to the work participants and a link between two nodes is represented by an arrow line indicating the direction from the source to the destination of file transfer (see FIG. 8A). FIG. 8A shows an example of the screen that shows file icons within which a file name is shown as well as the work participants. As indicated by this example, as data to be referenced to verify the uniqueness of a file, the unique ID from the attribute information 21, not the file name, is used, so that the user can change the file name arbitrarily. The flow model presentation screen 120 may present not only the information directly representing the file transfer actions, but also history information 27 to explain the file transfer actions.

Also, the flow model presentation screen 120 may present another style of a flow model in which the nodes of a tree structure correspond to the work participants and are arranged in a hierarchy of the work participants (nesting structure) (see FIG. 8B). Thereby, a flow model having a great number of nodes is presented so that its overview is easily intelligible. Furthermore, the flow model presentation screen 120 may present a flow mode as a time sequence list display in which the file transfer actions are arranged in time sequence in which they were performed.

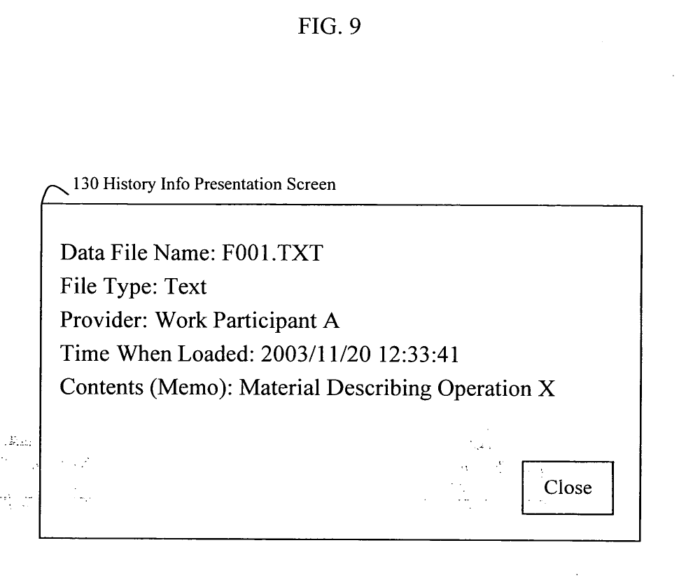

When a node (work participant) is selected in the flow model displayed on the flow model presentation screen 120, the apparatus for managing file transfer actions 1 may present the history information 27 for the node (work participant) on a history information presentation screen 130 (see FIG. 9). The history information is retrieved from the file transfer actions DB on the apparatus for managing file transfer actions 1 and presented by request from another terminal. Thereby, the user can know about the work participant at the other end of a file transfer action conveniently and can immediately notify the participant things about the file.

The process for visualizing file transfer actions is carried out as described above. This visualization has the following advantages: from the viewpoint of project management, how the work is developed can be grasped with the display of a comprehensive view of data file flows with close-up of the nodes of work participants; from the viewpoint of quality management, traceability (history management) of data files can be realized.

The present invention set forth hereinbefore may be embodied in other modified forms without departing from its spirit or essential characteristics, as will be illustrated below.

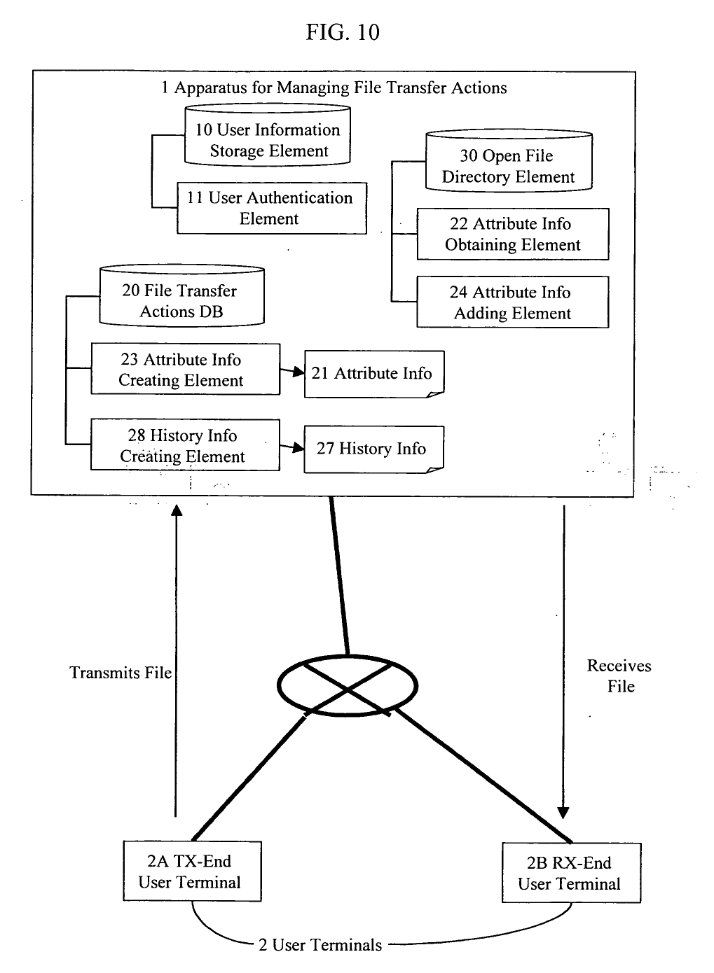

For example, while the peer-to-peer topology is applied to the file transfer system (see FIG. 1) in the described embodiment, the system may be built in a client-server topology (see FIG. 10). In the case of the client-server topology system, open files are located on the apparatus for managing file transfer actions 1, instead of being located on the user terminals 2. Consequently, even if a number of transfer requests for a particular file occur at a time, it is avoided that the load to process the requests is imposed on the user terminal 2 having the file. The file transfer system of client-server topology is applied to, for example, a file server system, document management system, and PDM.

For file transfer (communication), a variety of communication protocols may be employed, including, for example, a File Transfer Protocol (FTP) which is used for file transfer and a Simple Mail Transfer Protocol (SMTP) which is used for e-mail transmission.

1. A method for managing file transfer actions in a file transfer system comprising user terminals among which file transfer actions are performed and an apparatus for managing the file transfer actions among said user terminals, said method comprising the following steps which are performed by said apparatus:
accepting entry of a file to be made open or said file's attribute information that identifies one of the transfer actions of the file,
creating new attribute information for said file to be made open not including said attribute information and adding the new attribute information to said file,
updating said attribute information for said file to be made open including said attribute information, and
storing combination of the identifier of said file to be made open and the attribute information added to said file into a file transfer actions database,
wherein the new attribute information comprises a unique ID different from any previously issued unique ID and an arbitrary sub-ID, and
wherein the updated attribute information comprises a unique ID inherited from the attribute information from which the update derives, a sub-ID different from any previously issued sub-ID under the unique ID, and a parent sub-ID identical to the sub-ID from the attribute information from which the update derives.

2. The method for managing file transfer actions according to claim 1, wherein said storing step stores combination of the identifier of said file to be made open, the attribute information added to said file, and history information about the transfer actions of said file into the file transfer actions database, said history information comprising at least one of the following: user ID to identify the user who requested the file transfer action, activity to indicate the type of the file transfer action, file name assigned to the file, time and date when the file transfer action was performed, contents information to describe the contents of the file, and file type to indicate the type of the file.

3. A method for visualizing file transfer actions, based on the file transfer actions managed by the method for managing file transfer actions as recited in claim 1, said method comprising the following steps which are performed by said apparatus for managing the file transfer actions:
accepting entry of attribute information of said file,
retrieving data corresponding to file transfer actions having a unique ID derived from said attribute information from said file transfer actions database,
creating a flow model of a tree structure in which the tree is formed by connecting file transfer action data with a parent sub-ID to file transfer action data whose sub-ID matching the parent sub-ID, the root of the tree being data corresponding to the initial file load action, and
presenting said flow model.

4. The method for visualizing file transfer actions according to claim 3, wherein said flow model presenting step presents a directed graph with nodes of sub-IDs from said file transfer actions data, a link between two nodes being represented by an arrow-line indicating the direction from the source to the destination of file transfer.

5. The method for visualizing file transfer actions according to claim 3, wherein said flow model presenting step presents a flow model as a time sequence list display in which file transfer actions are arranged in time sequence in which the actions were performed.

6. A method for visualizing file transfer actions, based on the file transfer actions managed by the method for managing file transfer actions as recited in claim 1, said method comprising the following steps which are performed by said user terminals:
extracting attribute information relevant to a file,
getting data corresponding to file transfer actions in time sequence from said attribute information,
creating a flow model from the data, according to the sequence of said file transfer actions in time sequence, and
presenting said flow model.

7. An apparatus for managing file transfer actions in a file transfer system comprising user terminals among which file transfer actions are performed and the apparatus for managing the file transfer actions among said user terminals, said apparatus comprising:
a file transfer actions database to store information relevant to said file transfer actions, and
an attribute information creating element which creates attribute information per file to be stored into said file transfer actions database,
wherein said attribute information comprises a unique ID to identify said file, a sub-ID to identify one of transfer actions of said file, and a parent sub-ID to identify the preceding one of transfer actions of said file.

8. The apparatus for managing file transfer actions according to claim 7, further comprising a history information creating element which creates history information relevant to said file transfer actions,
wherein combination of said history information, the identifier of said file, and the attribute information added to said file is stored into said file transfer actions database, said history information comprising at least one of the following: user ID to identify the user who requested the file transfer action, activity to indicate the type of the file transfer action, file name assigned to the file, time and date when the file transfer action was performed, contents information to describe the contents of the file, and file type to indicate the type of the file.

9. The apparatus for managing file transfer actions according to claim 7 or 8, further comprising a user authentication element which authenticates users who perform said file transfer actions.

10. A user terminal in a file transfer system comprising user terminals among which file transfer actions are performed and an apparatus for managing the file transfer actions among said user terminals, said user terminal comprising:
an open file directory element to store open files,
an attribute information obtaining element through which the terminal gets attribute information attached to a file, and
an attribute information adding element which adds attribute information associated with a file to the file,
wherein said attribute information comprises a unique ID to identify said file, a sub-ID to identify one of transfer actions of said file, and a parent sub-ID to identify the preceding one of transfer actions of said file.
